(19) United States
(12) Patent Application Publication
(10) Pub. No.: US 2008/0320539 A1
(43) Pub. Date: Dec. 25, 2008

(54) Data Transmission Apparatus and Data Transmission Method

(75) Inventor: Hideki Ohkita, Kunitachi-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/131,791

(22) Filed: Jun. 2, 2008

(30) Foreign Application Priority Data
Jun. 19, 2007 (JP) 2007-161470

(51) Int. Cl. H04N 7/173

(52) U.S. Cl. 725/118

(57) ABSTRACT

According to one embodiment, a data transmission apparatus classifies a plurality of electronic devices into a plurality of groups in accordance with functions of the electronic devices, and generates list information indicative of a list of structures of the groups. Each of the groups includes a combination of an electronic device which is usable for video display and an electronic device which is usable for audio output, or an electronic device which is usable for both the video display and the audio output. The data transmission apparatus transmits the generated list information to the source device. In accordance with selection information which is output from the source device, the video transmission apparatus specifies destinations of transmission of video data and audio data which are output form the source device.

### CROSS-REFERENCE TO RELATED APPLICATIONS

This application is based upon and claims the benefit of priority from Japanese Patent Applications No. 2007-161470, filed Jun. 19, 2007, the entire contents of which are incorporated herein by reference.

### BACKGROUND

1. Field

One embodiment of the invention relates to a data transmission apparatus and a data transmission method for transmitting content data, which is output from a source device, to an electronic device.

2. Description of the Related Art

In recent years, an interface standard, such as High-Definition Multimedia Interface (HDMI), has been used as an interface for transmitting video data. The HDMI interface is used in order to transmit content data, such as a digital television signal, from a source device such as a DVD (Digital Versatile Disc) player to an electronic device such as a TV set, a projector or an audio system. The source device and the electronic device (also referred to as “sink device”) are connected over a single cable. Both video data and audio data, which are included in the content data that is output from the source device, are transmitted to the electronic device via a single cable.

However, since the cable connection restricts the places where the source device and the electronic device are disposed, it is difficult to dispose the source device and the electronic device at arbitrary places.

Jpn. Pat. Appln. KOKAI Publication No. 2006-246057 discloses a wireless network system which wirelessly connects a DVD device and electronic devices such as a TV and an audio device. In this wireless network system, the distance between the DVD device and each of the electronic devices is detected, and an electronic device, which is present within a predetermined distance from the DVD device, is preferentially wirelessly connected to the DVD device.

In the system of Jpn. Pat. Appln. KOKAI Publication No. 2006-246057, however, no particular consideration is given to the selection of combinations between an electronic device, which is to be used for video output, and an electronic device which is to be used for audio output. If the interface, such as HDMI, is wirelessly implemented, the source device can easily be wirelessly connected to a plurality of electronic devices.

It is thus necessary to realize a novel function for transmitting video data and audio data, which are included in content data that is output from a source device, to arbitrary electronic devices, respectively.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a structure of a wireless transmission system including a video transmission apparatus according to an embodiment of the present invention;

FIG. 2 shows an example of topology list information which is generated by the video transmission apparatus according to the embodiment;

FIG. 3 is an exemplary block diagram showing a structure of the video transmission apparatus according to the embodiment;

FIG. 4 is an exemplary view for explaining an operation of transmitting topology list information to a source device, which is executed by the video transmission apparatus according to the embodiment;

FIG. 5 is an exemplary view for explaining a process for a message with selection information, which is executed by the video transmission apparatus according to the embodiment;

FIG. 6 is an exemplary flow chart illustrating an example of the procedure of a series of processes which are executed by the video transmission apparatus according to the embodiment;

FIG. 7 is an exemplary block diagram showing another structure of the wireless transmission system including the video transmission apparatus according to the embodiment of the invention;

FIG. 8 shows another example of the topology list information which is generated by the video transmission apparatus according to the embodiment;

FIG. 9 is an exemplary block diagram showing another structure of the video transmission apparatus according to the embodiment; and

FIG. 10 is an exemplary flow chart illustrating another example of the procedure of a series of processes which are executed by the video transmission apparatus according to the embodiment.

### DETAILED DESCRIPTION

Various embodiments according to the invention will be described hereinafter with reference to the accompanying drawings. In general, according to one embodiment of the invention, there is provided A data transmission apparatus which is connected to a source device and transmits content data, which is output from the source device, to one or more of a plurality of electronic devices by a wireless signal, comprising: a function detection unit configured to detect functions of the plurality of electronic devices by wireless communication with each of the plurality of electronic devices; a list information generating unit configured to classify the plurality of electronic devices into a plurality of groups in accordance with the detected functions of the plurality of electronic devices and to generate list information indicative of a list of structures of the plurality of groups, each of the groups including a combination of an electronic device which is usable for video display and an electronic device which is usable for audio output, or an electronic device which is usable for both the video display and the audio output; a list information transmission unit configured to transmit the generated list information to the source device; and a data transmission control unit configured to specify, in accordance with selection information which is output from the source device and designates one of the plurality of electronic devices, a first electronic device of the plurality of electronic devices, to which video data contained in the content data is to be transmitted, and a second electronic device of the plurality of electronic devices, to which audio data contained in the content data is to be transmitted, to transmit the video data and the audio data contained in the content data to the specified first electronic device and the specified second electronic device by wireless signals if the specified first electronic device and the specified second electronic device are different electronic devices, and to transmit, if the specified first electronic device and the specified second electronic device are a single electronic device, the video data and the audio data contained in the content data to the single electronic device by a wireless signal.

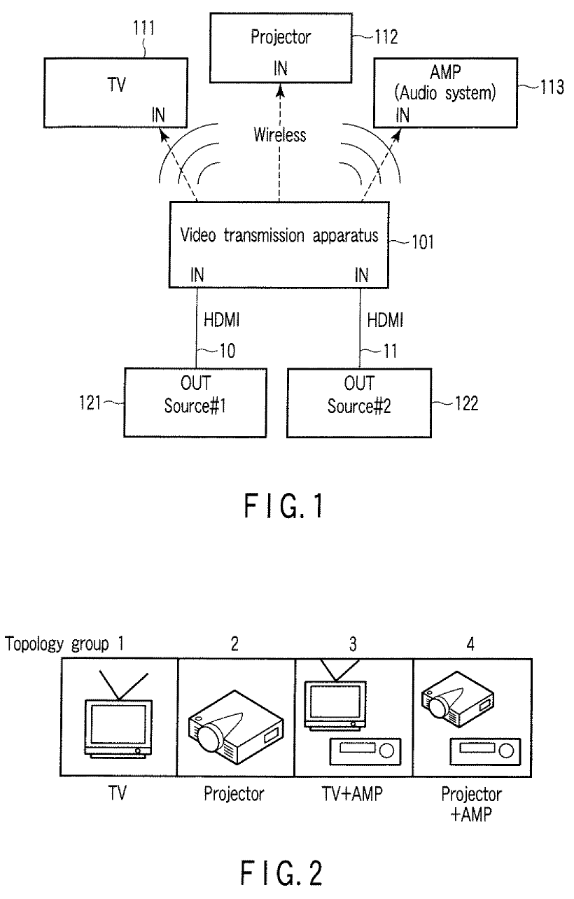

FIG. 1 shows an example of the structure of a wireless transmission system including a video transmission apparatus according to an embodiment of the present invention. This wireless transmission system comprises a video transmission apparatus 101, a TV set 111, a projector 112, an AV amplifier (audio system) 113, and source devices 121 and 122.

The video transmission apparatus 101 is the data transmission apparatus according to the present embodiment. The video transmission apparatus 101 transmits, by a wireless signal, content data which is output from the source devices 121 or 122, to at least one electronic device selected from a plurality of electronic devices (TV set 111, projector 112 and AV amplifier 113). The content data includes video data and audio data.

Each of the source devices 121 and 122 is a device such as a DVD player or an AV recorder. The source device 121 and 122 can reproduce content data including video data (non-compressed video data) and audio data, and can output a stream of the content data. An output terminal OUT of the source device 121 is connected to an input terminal IN of the video transmission apparatus 101 via, for example, a cable 10 according to the HDMI standard. Similarly, an output terminal OUT of the source device 122 is connected to another input terminal IN of the video transmission apparatus 101 via, for example, a cable 11 according to the HDMI standard.

Each of the TV set 111, projector 112 and AV amplifier 113 is an electronic device having a video display function or an audio output function, or both of the video display function and audio output function. Each of the TV set 111, projector 112 and AV amplifier 113 functions as a sink device which receives a stream (content data) that is output from the source device.

The video transmission apparatus 101 receives content data which is output from each of the source devices 121 and 122, and transmits, by a wireless signal, the received content data to at least one arbitrary electronic device which is selected from the TV set 111, projector 112 and AV amplifier 113. The wireless interface between the video transmission apparatus 101, on the one hand, and the TV set 111, projector 112 and AV amplifier 113, on the other hand, corresponds to, for example, a wirelessly implemented interface of an HDMI-standard cable, and the performance of this wireless interface is equivalent to the HDMI-standard cable. A high-speed wireless communication scheme, such as WirelessHD or UWB (Ultra Wideband), which has a higher transmission speed than a wireless LAN, is suitable as a wireless communication scheme that is used in this wireless transmission system. In this case, the video transmission apparatus 101 executes wireless communication by using a high-speed wireless communication scheme such as WirelessHD or UWB, and also each of the TV set 111, projector 112 and AV amplifier 113 executes wireless communication by using a high-speed wireless communication scheme such as WirelessHD or UWB. In the WirelessHD standard, wireless communication is executed by using a millimeter wave signal of a 60 GHz band.

The video transmission apparatus 101 can execute wireless communication with each of the TV set 111, projector 112 and AV amplifier 113 according to the communication procedure stipulated in, e.g. the HDMI standard. By the wireless communication, the video transmission apparatus 101 transmits content data including non-compressed video data, which is output from each of the source devices 121 and 122, selectively to the TV set 111, projector 112 and AV amplifier 113.

The video transmission apparatus 101 classifies a plurality of electronic devices (TV set 111, projector 112 and AV amplifier 113 in the example of FIG. 1) which are wirelessly connectable to the video transmission apparatus 101 into a plurality of groups (a plurality of topology groups) in accordance with the functions of the respective electronic devices, and generates list information (topology list information) indicative of a list of the structures of these groups. Each of the topology groups comprises a combination of an electronic device (sink device) which is usable for video display and an electronic device (sink device) which is usable for audio output, or comprises one electronic device which is usable for both video display and audio output.

The TV set (also referred to as “TV device”) 111 is a sink device which has both of a video display function and an audio output function. The projector 112 is a sink device which has a video display function but does not have an audio output function. The AV amplifier 113 is a sink device which has an audio output function but does not have a video display function. Thus, the video transmission apparatus 101 generates the topology list information, as shown in FIG. 2, in accordance with the functions of the TV set 111, projector 112 and AV amplifier 113.

In the topology list information shown in FIG. 2, the TV set 111, projector 112 and AV amplifier 113 are classified into four topology groups. In FIG. 2, a topology group comprising only the projector 112 having the video display function alone is treated as one of the topology groups, in consideration of the fact that there is content data which includes only video data and does not include audio data.

Specifically, only the TV set 111 belongs to a topology group 1. The topology group 1 is a topology group which executes both video display and audio output with use of the TV set 111. In the case where the topology group 1 is selected by, for example, the source device 121, both video data and audio data, which are included in the content data that is output from the source device 121, are transmitted from the video transmission apparatus 101 to the TV set 111 via a wireless communication channel which is established between the video transmission apparatus 101 and the TV set 111.

Only the projector 112 belongs to a topology group 2. The topology group 2 is a topology group which executes video display with use of the projector 112. In the case where the topology group 2 is selected by, for example, the source device 121, both video data and audio data which are included in the content data that is output from the source device 121, or only the video data which is included in the content data, is transmitted from the video transmission apparatus 101 to the projector 112 via a wireless communication channel which is established between the video transmission apparatus 101 and the projector 112.

Both the TV set 111 and the AV amplifier 113 belong to a topology group 3. The topology group 3 is a topology group which executes video display with use of the TV set 111 and executes audio output with use of the AV amplifier 113. In the case where the topology group 3 is selected by, for example, the source device 121, video data, which is included in the content data that is output from the source device 121, is transmitted from the video transmission apparatus 101 to the TV set 111 via a wireless communication channel which is established between the video transmission apparatus 101 and the TV set 111. On the other hand, audio data, which is included in the content data that is output from the source device 121, is transmitted from the video transmission apparatus 101 to the AV amplifier 113 via a wireless communication channel which is established between the video transmission apparatus 101 and the AV amplifier 113.

Both the projector 112 and the AV amplifier 113 belong to a topology group 4. The topology group 4 is a topology group which executes video display with use of the projector 112 and executes audio output with use of the AV amplifier 113. In the case where the topology group 4 is selected by, for example, the source device 121, video data, which is included in the content data that is output from the source device 121, is transmitted from the video transmission apparatus 101 to the projector 112 via a wireless communication channel which is established between the video transmission apparatus 101 and the projector 112. On the other hand, audio data, which is included in the content data that is output from the source device 121, is transmitted from the video transmission apparatus 101 to the AV amplifier 113 via a wireless communication channel which is established between the video transmission apparatus 101 and the AV amplifier 113.

The video transmission apparatus 101 sends the topology list information to each of the source devices 121 and 122. Each of the source devices 121 and 122 can select an arbitrary one of the plural topology groups which are indicated by the topology list information.

For example, the plural topology groups which are indicated by the topology list information can be assigned to one operation button, like a channel switch button, which is provided on the source device. Each time the user presses the operation button, the topology group, which is to be selected, is successively switched in the order of topology groups 1, 2, 3, 4, 1, 2, . . . Alternatively, the plural topology groups may be assigned to a plurality of operation buttons which are provided on the source device.

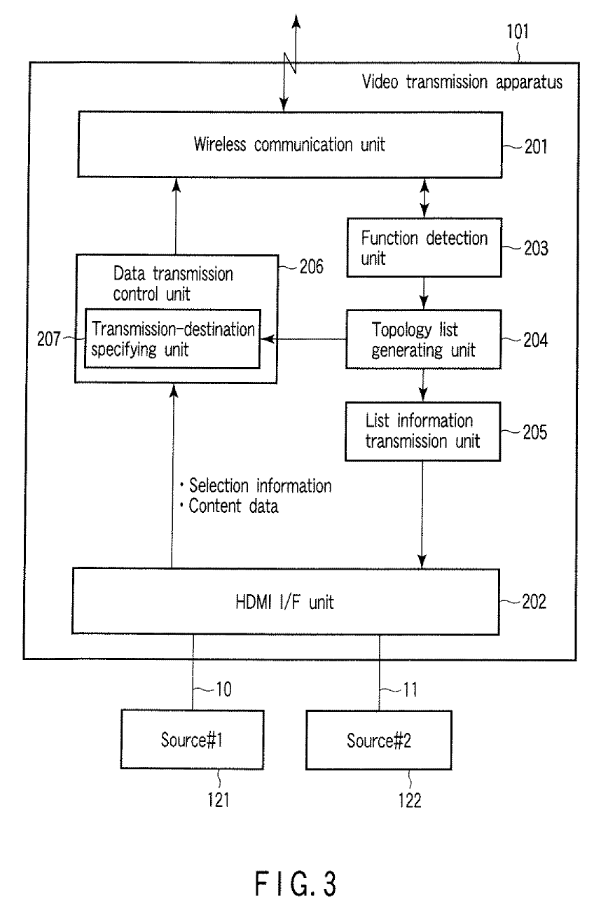

Next, referring to FIG. 3, an example of the structure of the video transmission apparatus 101 is described.

The video transmission apparatus 101 comprises a wireless communication unit 201, an HDMI interface unit 202, a function detection unit 203, a topology list generating unit 204, a list information transmission unit 205, a data transmission control unit 206, and a transmission-destination specifying unit 207.

The wireless communication unit 201 executes communication with each of the TV set 111, projector 112 and AV amplifier 113. The HDMI interface unit 202 is connected to the source device 121 via the HDMI cable 10, and is connected to the source device 122 via the other HDMI cable 11. The HDMI interface unit 202 executes communication with the source devices 121 and 122 via the HDMI cables 10 and 11.

The function detection unit 203 detects the functions of sink devices, which are wirelessly connectable to the video transmission apparatus 101, by wireless communication with the sink devices. For example, the function detection unit 203 executes a scan process for detecting sink devices, which are wirelessly connectable to the video transmission apparatus 101, and detects the functions (also referred to as “capabilities”) of the detected sink devices. For example, in the case where the TV set 111, projector 112 and AV amplifier 113 are present in an area within the reach of radio waves (wireless signals) from the video transmission apparatus 101, the function detection unit 203 executes wireless communication with the TV set 111, projector 112 and AV amplifier 113 via the wireless communication unit 201, thereby detecting the functions of the TV set 111, projector 112 and AV amplifier 113.

In the HDMI standard, unique device type information (e.g. unique logical address) is assigned to each of the kinds of plural sink devices. Accordingly, the function detection unit 203 can detect the functions of the plural sink devices by acquiring the device type information (sink type information) from the plural sink devices which are detected by, e.g. the scan process.

The topology list generating unit 204 classifies a plurality of sink devices into a plurality of topology groups in accordance with the functions of the plural sink devices which are detected by the function detection unit 203. Each topology group includes a combination of a sink device which is usable for video display and a sink device which is usable for audio output, or a single sink device which is usable for both video display and audio output. The topology list generating unit 204 generates the above-described topology list information which is indicative of a list of structures of plural topology groups obtained by the classification process (for example, the names of sink devices belonging to each topology group).

The list information transmission unit 205 transmits the topology list information, which is generated by the topology list generating unit 204, to each of the source devices 121 and 122. In the HDMI-standard cable, a CEC (Consumer Electronics Control) line, which is a control signal line for transferring control information and statuses, is defined in addition to data transmission lines for data transfer. Thus, the CEC line can be used for transmission of the topology list information to each of the source devices 121 and 122. The data transmission lines comprise, for instance, three pairs of differential signal lines.

Each of the source devices 121 and 122 can output content data (non-compressed video data, audio data) via the three pairs of differential signal lines. In this case, the transmission of audio data is executed, for example, in a blanking period of video data.

The data transmission control unit 206 specifies a transmission destination of video data which is included in content data that is output from the source device 121 or 122, and a transmission destination of audio data included in the content data. The data transmission control unit 206 transmits video data to the specified transmission destination of video data by a wireless signal, and transmits audio data to the specified transmission destination of audio data by a wireless signal. In order to specify the transmission destinations of video data and audio data, the data transmission control unit 206 includes the transmission-destination specifying unit 207.

The transmission-destination specifying unit 207 specifies a first sink device (target device) to which video data included in the content data that is output from the source device 121 (or 122) is to be transmitted, and a second sink device (target device) to which audio data included in the content data is to be transmitted, in accordance with selection information for designating one of the plural topology groups which is output from the source device 121 (or 122).

In the case where the specified first sink device and the specified second sink device are different sink devices, the data transmission control unit 206 executes wireless communication with each of the specified first sink device and second sink device via the wireless communication unit 201 and transmits the video data and audio data, which are included in the content data that is output from the source device 121 (or 122), to the specified first sink device and second sink device, that is, two different sink devices, by wireless signals. Since the video data and audio data are included in the stream of content data which is output from the source device, the data transmission control unit 206 extracts the video data and audio data from the received stream, transmits the extracted video data to the specified first sink device, and transmits the extracted audio data to the specified second sink device.

On the other hand, in the case where the specified first sink device and the specified second sink device are the same sink device, the data transmission control unit 206 executes wireless communication with the single sink device via the wireless communication unit 201, and transmits the video data and audio data, which are included in the content data that is output from the source device 121 (or 122), to the single sink device by a wireless signal.

The above-described selection information can be added, for example, to a message which is output from the source device. This message is a message by which the source device instructs the transmission-destination sink device, to which content data is to be transmitted, to execute video display or audio output. This message can be used, for example, in order to realize a one-touch play function which is defined by the HDMI standard. The one-touch play function is such a function that if the user presses only once an operation button which is provided on the source device, the source device can be caused to execute output of a stream of content data and the transmission-destination sink device, which is coupled to the source device, can be caused to start a processing of the stream (video display, audio output).

In the system of the present embodiment, in order to realize the one-touch play function by which an arbitrary sink device is made usable as a transmission-destination sink device, the message for the one-touch play is sent from the source device to the video transmission apparatus 101, for example, in the state in which the selection information is added to the message for the one-touch play. Specifically, if the user presses a certain operation button which is provided on the source device, the source device outputs a message for one-touch play which instructs the transmission-destination sink device to execute video display or audio output, and starts the output of content data. Selection information which designates one topology group is added to the message as an argument corresponding to the message. The message to which the selection information is added is transmitted from the source device to the video transmission apparatus 101 via, for example, the above-described CEC line, and the content data is transmitted from the source device to the video transmission apparatus 101 via the data transmission lines.

In accordance with the selection information which is added to the message that is sent from the source device, the transmission-destination specifying unit 207 specifies a first sink device and a second sink device from the plural sink devices.

In the case where the specified first sink device and specified second sink device are different sink devices, the data transmission control unit 206 executes wireless communication with each of the specified first sink device and specified second sink device via the wireless communication unit 201, and transmits, by a wireless signal, the message that is output from the source device and the video data included in the content data that is output from the source device, to the specified first sink device, and also transmits, by a wireless signal, the message and the audio data included in the content data that is output from the source device, to the specified second sink device. Thereby, the two different sink devices can be caused to execute one-touch play functions.

On the other hand, in the case where the specified first sink device and specified second sink device are the same sink device, the data transmission control unit 206 executes wireless communication with this single sink device via the wireless communication unit 201, and transmits, by a wireless signal, the message that is output from the source device and the video data and audio data included in the content data that is output from the source device, to the single sink device.

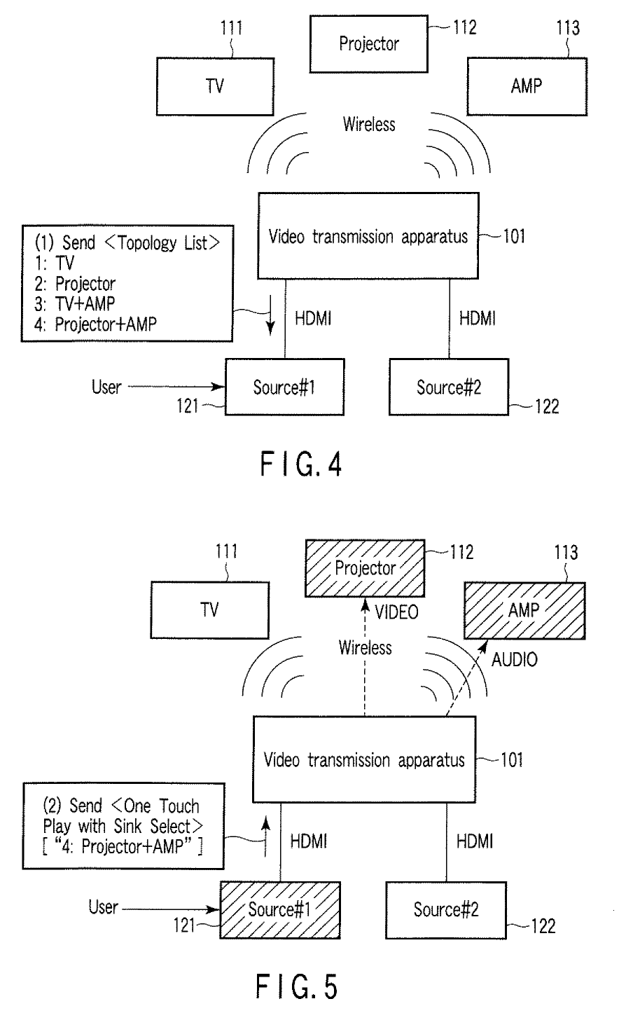

Next, referring to FIG. 4 and FIG. 5, an example of the operation of the video transmission apparatus 101 is described.

FIG. 4 shows an operation of transmitting topology list information to each of the source devices 121 and 122 from the video transmission apparatus 101.

The video transmission apparatus 101 generates topology list information which is indicative of the structures of the topology groups 1 to 4. The topology list information includes sink device identification information which is associated with each of the topology groups 1 to 4. The sink device identification information is indicative of one or more sink devices belonging to the associated topology group. For example, the sink device identification information that is associated with the topology group 1 includes identification information (TV) which identifies the TV set. The sink device identification information that is associated with the topology group 2 includes identification information (Projector) which identifies the projector. The sink device identification information that is associated with the topology group 3 includes identification information (TV) which identifies the TV set and identification information (AMP) which identifies the AV amplifier. The sink device identification information that is associated with the topology group 4 includes identification information (Projector) which identifies the projector and identification information (AMP) which identifies the AV amplifier. For example, the topology groups 1 to 4 may be assigned to four operation buttons which are provided on the sink device. Needless to say, the topology groups 1 to 4 may be assigned to a single operation button which is provided on the sink device.

FIG. 5 shows an operation of the video transmission apparatus 101 which is executed in response to reception of the message with selection information, which is output from the source device 121.

Now assume a case in which the topology groups 1 to 4 are assigned to four operation buttons which are provided on the sink device. If one of the four operation buttons is operated by the user, the source device 121 selects the topology group that is assigned to the operated operation button, sends the message with selection information, which designates the selected topology group, to the video transmission apparatus 101 via the CEC line, starts a process of playing back content data, and sends the stream of the content data to the video transmission apparatus 101 via the data transmission lines. This stream includes video data and audio data.

FIG. 5 shows, for example, a case in which the message with selection information (<One Touch Play with Sink Select> [“4:Projector+AMP”]), which designates the topology group 4, is output. The selection information [“4:Projector+AMP”], which is added to the message <One Touch Play with Sink Select> includes a group number (=4) which designates the topology group 4 and sink device identification information (projector and AMP) which belongs to the topology group 4.

Upon receiving the message with the selection information which designates the topology group 4, the video transmission apparatus 101 specifies, in accordance with the selection information, the projector 112 as the first sink device to which the video data is to be transmitted, and the AV amplifier 113 as the second sink device to which the audio data is to be transmitted. Then, the video transmission apparatus 101 removes the selection information from the received message <One Touch Play with Sink Select>[“4:Projector+AMP”], transmits only the message <One Tough Play> to the projector 112 by a wireless signal, and transmits the video data, which is included in the content data received from the source device 121, to the projector 112 by a wireless signal. Further, the video transmission apparatus 101 transmits the message <One Tough Play> to the AV amplifier 113 by a wireless signal, and transmits the audio data, which is included in the content data received from the source device 121, to the AV amplifier 113 by a wireless signal.

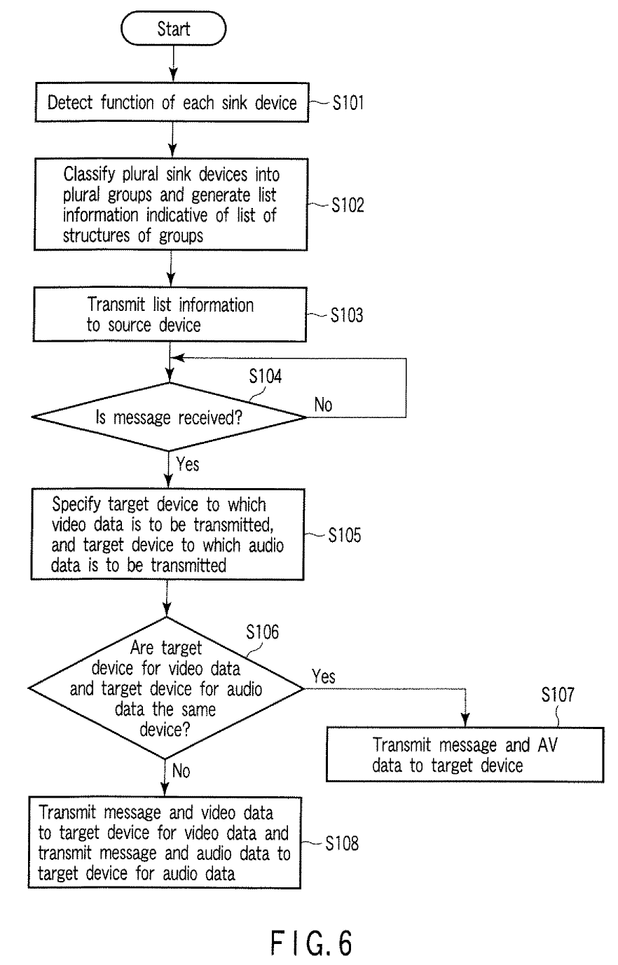

Next, referring to a flow chart of FIG. 6, a description is given of the procedure of a series of processes which are executed by the video transmission apparatus 101.

To start with, the video transmission apparatus 101 executes wireless communication with each of sink devices which are wirelessly connectable to the video transmission apparatus 101, and detects the functions of the respective sink devices (block S101). In block S101, for example, the video transmission apparatus 101 repeatedly executes, while varying the kind of sink devices that are objects of search, a process of broadcasting an inquiry packet for searching for a specified kind of sink devices and determining the presence/absence of a reply from the specified kind of sink devices. Thereby, the video transmission apparatus 101 can detect the functions of the sink devices which are wirelessly connectable to the video transmission apparatus 101.

Subsequently, the video transmission apparatus 101 classifies the sink devices into a plurality of topology groups which can be composed of these sink devices, in accordance with the detected functions of the sink devices, and generates topology list information which is indicative of a list of the structures of the plural topology groups (block S102). The video transmission apparatus 101 transmits the generated topology list information to each of the source devices (block S103).

If the video transmission apparatus 101 receives a message with selection information which is sent from a certain source device (YES in block S104) the video transmission apparatus 101 specifies, in accordance with the selection information included in the message with the selection information, a first sink device (target device for video data) to which video data is to be transmitted from the source device, and a second sink device (target device for audio data) to which audio data is to be transmitted from the source device (block S105). In block S105, the video transmission apparatus 101 refers to the generated topology list information and determines sink devices which belong to the topology group designated by the selection information. If the selection information includes sink device identification information of each sink device belonging to the topology group that is designated by the selection information, the video transmission apparatus 101 can determine the target device for video data and the target device for audio data, even without referring to the generated topology list information.

Next, the video transmission apparatus 101 determines whether the target device for video data and the target device for audio data are the same single sink device or not (block S106).

If the target device for video data and the target device for audio data are the same single sink device (YES in block S106), the video transmission apparatus 101 establishes wireless connection with the single sink device, and transmits to the single sink device the message that is received from the source device and the content data (video data and audio data) that is received from the source device (block S107).

If the target device for video data and the target device for audio data are two different sink devices (NO in block S106) , the video transmission apparatus 101 establishes wireless connection with the sink device that is specified as the target device for video data, and establishes wireless connection with the sink device that is specified as the target device for audio data. The video transmission apparatus 101 transmits to the sink device that is specified as the target device for video data the message that is received from the source device and the video data included in the content data that is received from the source device, and transmits to the sink device that is specified as the target device for audio data the message that is received from the source device and the audio data included in the content data that is received from the source device (block S108).

As has been described above, in the present embodiment, the video data and audio data, which are included in the content data from the source device, can be transmitted to at least one arbitrary sink device of the plural sink devices. In particular, with use of the message to which the selection information is added, it becomes possible to realize the one-touch play function by which even in an environment in which wireless connection to a plurality of sink devices can selectively be established, an arbitrary sink device can be caused to automatically execute video display or audio output.

In the meantime, regardless of the message, only the selection information may be sent from the sink device to the video transmission apparatus 101.

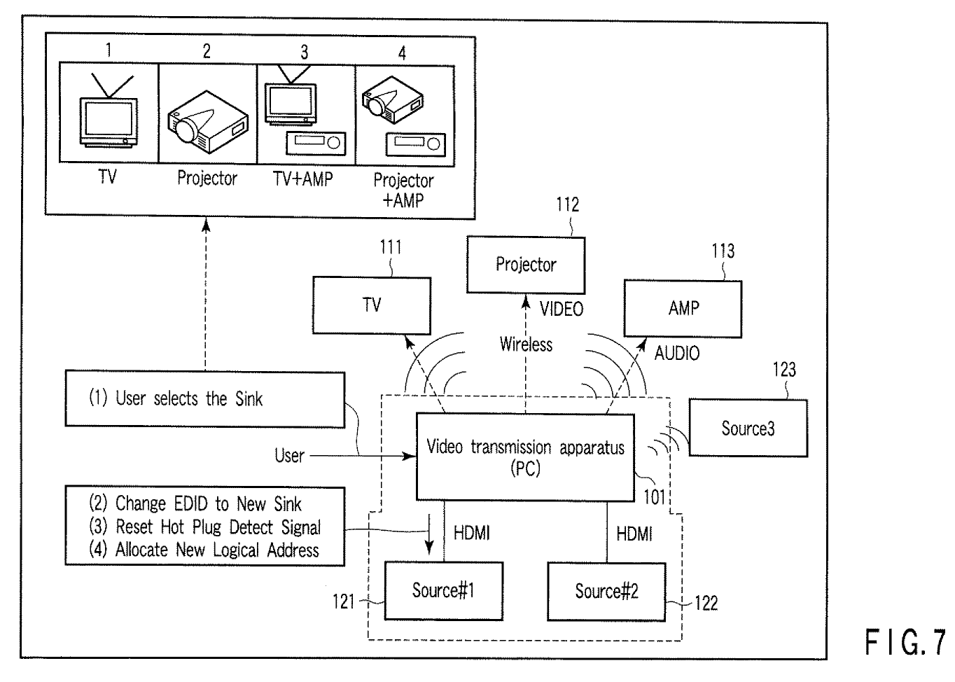

Next, referring to FIG. 7, another example of the structure of the wireless transmission system including the video transmission apparatus 101 according to the present embodiment is described.

In the wireless transmission system shown in FIG. 7, the video transmission apparatus 101 is composed of an information processing apparatus such as a personal computer. This video transmission apparatus 101 has a function of selecting, in accordance with the user's operation, one topology group, which is to be used, from a plurality of topology groups which are indicated by topology list information. Specifically, the video transmission apparatus 101 displays the generated topology list information on a screen that is provided on the video transmission apparatus 101 or on a screen of a sink device such as the TV set 111, and selects one topology group, which is to be used, from the plural topology group in accordance with the user's operation of an input device (e.g. an operation button, a keyboard, a remote-control unit or a mouse) which is provided on the video transmission apparatus 101. By the function of the video transmission apparatus 101, the user can easily switch a transmission-destination sink device (or transmission-destination sink devices) which is to be caused to execute video display or audio output.

The switching operation of the transmission-destination sink device is executed, for example, in the following procedure.

(1) Responding to a request from the user, the video transmission apparatus 101 displays the generated topology list information (topology groups 1, 2, 3 and 4) on a screen of a sink device such as the TV set 111. The user operates the input device provided on the video transmission apparatus 101, thereby designating one of the topology groups 1, 2, 3 and 4. The video transmission apparatus 101 selects the topology group which is designated by the user, and specifies a first sink device (target device for video data) to which video data is to be transmitted and a second sink device (target device for audio data) to which audio data is to be transmitted from a plurality of sink devices in accordance with the selected topology group. The video transmission apparatus 101 transmits the video data from the source device to the target device for video data by a wireless signal and transmits the audio data from the source device to the target device for audio data by a wireless signal.

For example, now assume a case where the topology group 4 is newly designated by the user in the state in which video data and audio data are being transmitted to the TV set 111. The video transmission apparatus 101 establishes wireless connection with each of the projector 112 and AV amplifier 113 which belong to the topology group 4, and start a process of transmitting the video data from the source device to the projector 112 by a wireless signal and a process of transmitting the audio data from the source device to the AV amplifier 113 by a wireless signal.

In this case, it may be possible that the video data format (e.g. a video data resolution and a pixel encoding scheme (RGB 4:4:4, YCrCb 4:4:4, YCrCb 4:2:2, YCrCb 4:2:0, etc.)) which is displayable by the TV set 111 is different from the video data format which is displayable by the projector 112. Similarly, it is possible that the audio data format (e.g. a format of a signal of audio data) which is processible by the TV set 111 is different from the audio data format which is processible by the AV amplifier 113.

To cope with this problem, the video transmission apparatus 101 sends to the source device the device information of the newly selected target device for video data, for example, the device information of the projector 112. The device information is indicative of the video data format that is displayable by the newly selected target device for video data. In addition, the video transmission apparatus 101 sends to the source device the device information of the newly selected target device for audio data which is indicative of the audio data format that is processible by the newly selected target device for audio data, for example, the device information of the AV amplifier 113.

Each of sink devices which support the HDMI standard has information called EDID (Extended Display Identification Data). This information includes device information which is indicative of the video data format, audio data format, etc. which are supported by the corresponding sink device. Therefore, by using the EDID of, for instance, the projector 112 and the AV amplifier 113, the video transmission apparatus 101 can inform the source device of the video data format that is displayable by the projector 112 and the audio data format that is processible by the AV amplifier 113.

This informing process can be executed, for example, by the following procedure.

(2) For example, at a time of switching from the topology group 1 to the topology group 4, the video transmission apparatus 101 updates the EDID of the sink device, which is to be reported to the source device, from the information indicative of the video data format that is displayable by the TV set 111 and the audio data format that is processible by the TV set 111 to the information indicative of the video data format that is displayable by the projector 112 and the audio data format that is processible by the AV amplifier 113.

(3) Next, the video transmission apparatus 101 resets a hot plug detect signal which is defined in the HDMI cable. Specifically, the video transmission apparatus 101 once sets the hot plug detect signal in the disable state and then sets the hot plug detect signal in the enable state. The hot plug detect signal is a signal for informing the source device that the sink device has transitioned into the ready state. When the hot plug detect signal is enabled, the source device automatically starts the process of acquiring the EDID of the sink device. Thereby, the video transmission apparatus 101 can inform the source device of the updated new EDID (the information indicative of the video data format that is displayable by the projector 112 and the information indicative of the audio data format that is processible by the AV amplifier 113).

(4) Thereafter, the video transmission apparatus 101 executes, as needed, a process of allocating a new logical address to the source device.

The source device encodes the video data in a video data format which is displayable by the new sink device, and outputs the encoded video data. In addition, the source device encodes the audio data in an audio data format which is processible by the new sink device, and outputs the encoded audio data.

In the case where the video transmission apparatus 101 is composed of a personal computer, the source device can be realized, for example, by a DVD drive which is built in the video transmission apparatus 101 and software which controls the DVD drive.

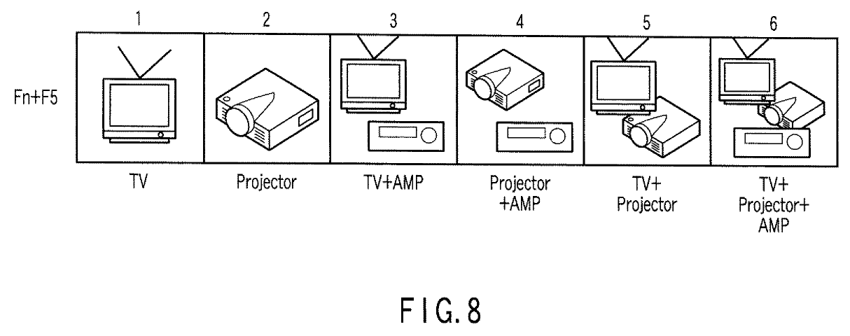

FIG. 8 shows other examples of topology groups.

In the topology list information shown in FIG. 8, topology groups 5 and 6 are provided in addition to the above-described topology groups 1 to 4.

The TV set 111 and projector 112 belong to the topology group 5. The topology group 5 is used, for example, in order to simultaneously display two different screen images on two sink devices (TV set 111 and projector 112).

The TV set 111, projector 112 and AV amplifier 113 belong to the topology group 6. The topology group 6 is used, for example, in order to simultaneously display two different screen images on two sink devices (TV set 111 and projector 112) and to cause the AV amplifier 113 to execute a process of outputting audio data.

The switching of the topology group that is to be used may also be executed, for example, by a key operation on the keyboard. For example, each time the user presses the “Fn” key and “F5” key at the same time, the topology group that is to be used can be switched in the order of, e.g. topology group 1, 2, 3, 4, 5, 6, 1, 2, . . . .

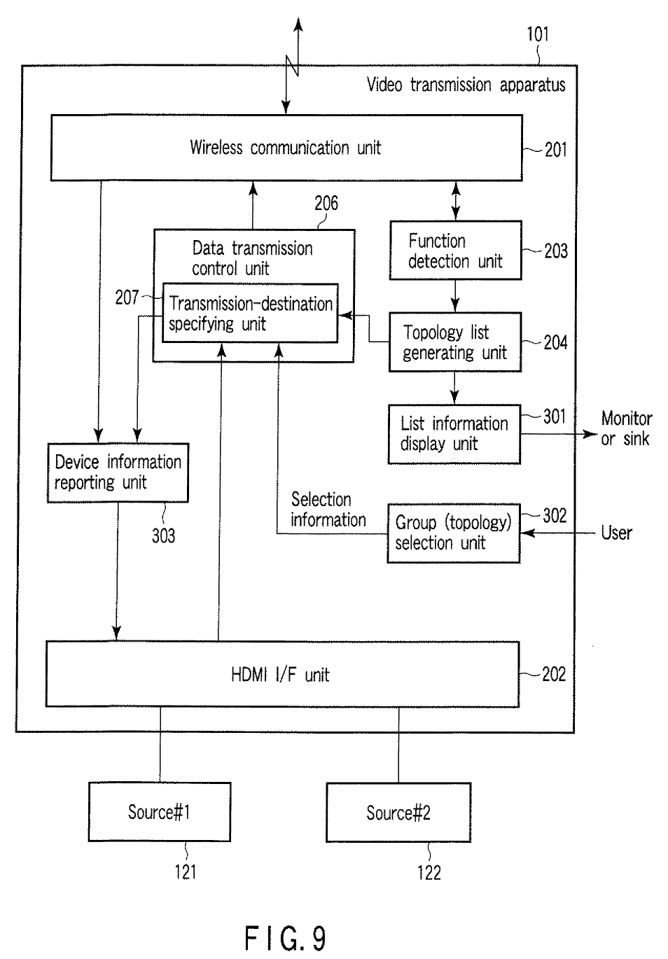

Next, an example of the structure of the video transmission apparatus 101, which is applied to the system configuration shown in FIG. 7, is described with reference to FIG. 9.

This video transmission apparatus 101 includes a list information display unit 301 and a group selection unit 302 in place of the list information transmission unit 205 that has been described with reference to FIG. 3. Further, the video transmission apparatus 101 includes a device information reporting unit 303. In the other respects, the structure shown in FIG. 9 is the same as that shown in FIG. 3.

The list information display unit 301 displays, in accordance with a request from the user, topology list information, which is generated by the topology list generating unit 204, on a screen provided on the video transmission apparatus 101 or a screen of the sink device. The group selection unit 302 selects, in accordance with the user's operation, one of a plurality of topology groups which are indicated by the topology list information.

The transmission-destination specifying unit 207 specifies a first sink device (target device for video data) to which video data included in the content data that is output from the source device is to be transmitted, and a second sink device (target device for audio data) to which audio data included in the content data is to be transmitted, in accordance with the topology group that is selected by the group selection unit 302.

The device information reporting unit 303 reports to the source device the device information of the specified target device for video data, which indicates the video data format that is displayable by the specified target device for video data, and the device information of the specified target device for audio data, which indicates the audio data format that is processible by the specified target device for audio data.

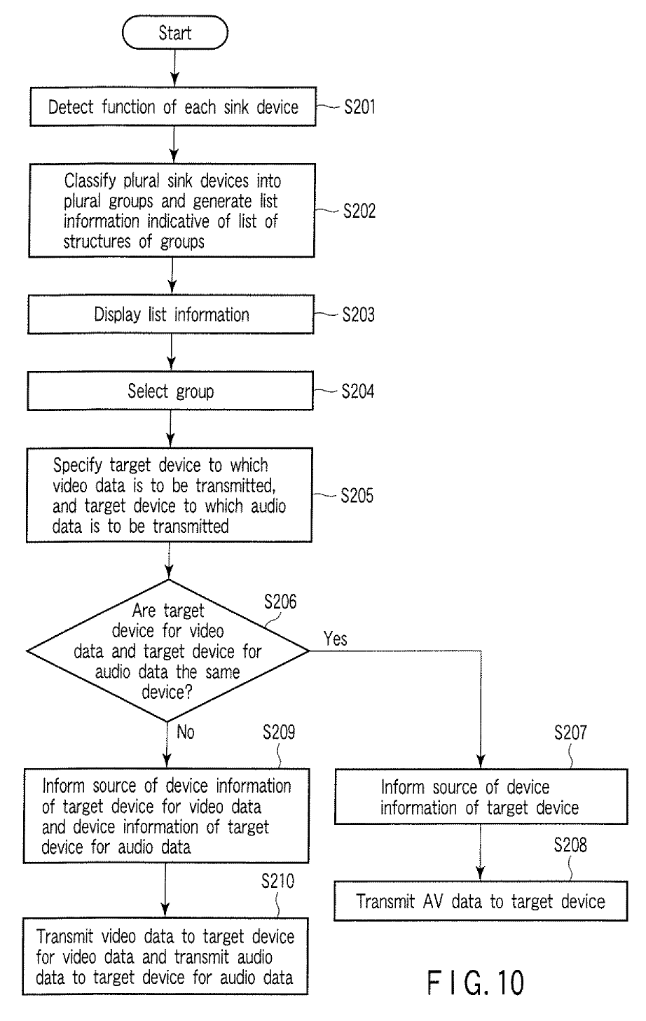

Next, referring to FIG. 10, a description is given of the procedure of a series of processes which are executed by the video transmission apparatus 101 shown in FIG. 10.

To start with, the video transmission apparatus 101 executes wireless communication with each of sink devices which are wirelessly connectable to the video transmission apparatus 101, and detects the functions of the respective sink devices (block S201). In block S201, for example, the video transmission apparatus 101 repeatedly executes, while varying the kind of sink devices that are objects of search, a process of broadcasting an inquiry packet for searching for a specified kind of sink devices and determining the presence/absence of a reply from the specified kind of sink devices. Thereby, the video transmission apparatus 101 can detect the functions of the sink devices which are wirelessly connectable to the video transmission apparatus 101.

Subsequently, the video transmission apparatus 101 classifies the detected sink devices into a plurality of topology groups which can be composed of these sink devices, in accordance with the detected functions of the sink devices, and generates topology list information which is indicative of a list of the structures of the plural topology groups (block S202). The video transmission apparatus 101 displays the generated topology list information on the screen provided on the video transmission apparatus 101 or on the screen of the sink device (block S203). Then, the video transmission apparatus 101 selects one of the topology groups in accordance with the user's operation (block 5204).

The video transmission apparatus 101 specifies, in accordance with the selected topology group, a first sink device (target device for video data) to which video data is to be transmitted from the source device, and a second sink device (target device for audio data) to which audio data is to be transmitted from the source device (block S205).

Next, the video transmission apparatus 101 determines whether the target device for video data and the target device for audio data are the same single sink device or not (block S206).

If the target device for video data and the target device for audio data are the same single sink device (YES in block S206), the video transmission apparatus 101 sends to the source device the device information of the single sink device (the device information is indicative of the video data format that is displayable by the single sink device and the audio data format that is processible by the single sink device) (block S207). Then, the video transmission apparatus 101 establishes wireless connection with the single sink device, and transmits to the single sink device the content data (video data and audio data) that is received from the source device (block S208).

If the target device for video data and the target device for audio data are two different sink devices (NO in block S206), the video transmission apparatus 101 sends to the source device the device information of the target device for video data (the device information indicative of the video data format that is displayable by the target device for video data) and the device information of the target device for audio data (the device information indicative of the audio data format that is processible by the target device for audio data) (block S209).

Then, the video transmission apparatus 101 establishes wireless connection with each of the sink device that is specified as the target device for video data and the sink device that is specified as the target device for audio data, transmits to the sink device that is specified as the target device for video data the video data included in the content data that is received from the source device, and transmits to the sink device that is specified as the target device for audio data the audio data included in the content data that is received from the source device (block S210).

As has been described above, with the structure of the video transmission apparatus shown in FIG. 9, too, the video data and audio data, which are included in the content data from the source device, can be transmitted to at least one arbitrary sink device of the plural sink devices. In addition, the combination of transmission-destination sink devices can easily be varied in accordance with the operation of the video transmission apparatus 101 by the user.

The functions of the function detection unit 203, topology list generating unit 204, list information transmission unit 205, data transmission control unit 206, transmission-destination specifying unit 207, list information display unit 301, group selection unit 302 and device information reporting unit 303, which have been described with reference to FIG. 3 and FIG. 9, can be realized by a communication control program which is executed by the CPU that is provided in the video transmission apparatus 101. In this case, the process described in the flow chart of FIG. 6 and the process described in the flow chart of FIG. 10 can be executed by the CPU. Needless to say, the functions of the function detection unit 203, topology list generating unit 204, list information transmission unit 205, data transmission control unit 206, transmission-destination specifying unit 207, list information display unit 301, group selection unit 302 and device information reporting unit 303 may be realized by dedicated purpose-specific circuits, or these functions may be realized by a microcomputer or a DSP.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data transmission apparatus which is connected to a source device and transmits content data, which is output from the source device, to one or more of a plurality of electronic devices by a wireless signal, comprising:
a function detection unit configured to detect functions of the plurality of electronic devices by wireless communication with each of the plurality of electronic devices;
a list information generating unit configured to classify the plurality of electronic devices into a plurality of groups in accordance with the detected functions of the plurality of electronic devices and to generate list information indicative of a list of structures of the plurality of groups, each of the groups including a combination of an electronic device which is usable for video display and an electronic device which is usable for audio output, or an electronic device which is usable for both the video display and the audio output;
a list information transmission unit configured to transmit the generated list information to the source device; and
a data transmission control unit configured to specify, in accordance with selection information which is output from the source device and designates one of the plurality of electronic devices, a first electronic device of the plurality of electronic devices, to which video data contained in the content data is to be transmitted, and a second electronic device of the plurality of electronic devices, to which audio data contained in the content data is to be transmitted, to transmit the video data and the audio data contained in the content data to the specified first electronic device and the specified second electronic device by wireless signals if the specified first electronic device and the specified second electronic device are different electronic devices, and to transmit, if the specified first electronic device and the specified second electronic device are a single electronic device, the video data and the audio data contained in the content data to the single electronic device by a wireless signal.

2. The data transmission apparatus according to claim 1, wherein the source device outputs, in response to an operation of a predetermined button provided on the source device, a message which instructs a transmission-destination electronic device to execute video display or audio output and to which the selection information is added, and starts output of the content data, and
the data transmission control unit specifies the first electronic device and the second electronic device in accordance with the selection information which is added to the message that is output from the source device.

3. The data transmission apparatus according to claim 2, wherein the data transmission control unit transmits, if the specified first electronic device and the specified second electronic device are different electronic devices, the message and the video data contained in the content data to the specified first electronic device by a wireless signal and the message and the audio data contained in the content data to the specified second electronic device by a wireless signal.

4. The data transmission apparatus according to claim 3, wherein the data transmission control unit transmits, if the specified first electronic device and the specified second electronic device are a single electronic device, the message and the video data and the audio data contained in the content data to the single electronic device by a wireless signal.

5. A data transmission apparatus which transmits content data, which is output from a source device, to one or more of a plurality of electronic devices by a wireless signal, comprising:
a function detection unit configured to detect functions of the plurality of electronic devices by wireless communication with each of the plurality of electronic devices;
a list information generating unit configured to classify the plurality of electronic devices into a plurality of groups in accordance with the detected functions of the plurality of electronic devices and to generate list information indicative of a list of structures of the plurality of groups, each of the groups including a combination of an electronic device which is usable for video display and an electronic device which is usable for audio output, or an electronic device which is usable for both the video display and the audio output;
a list information display unit configured to display the generated list information on a screen;
a selection unit configured to select, in accordance with a user's operation, one of the plurality of groups which are indicated by the list information; and
a data transmission control unit configured to specify, in accordance with the selected group, a first electronic device of the plurality of electronic devices, to which video data contained in the content data is to be transmitted, and a second electronic device of the plurality of electronic devices, to which audio data contained in the content data is to be transmitted, to transmit the video data and the audio data contained in the content data to the specified first electronic device and the specified second electronic device by wireless signals if the specified first electronic device and the specified second electronic device are different electronic devices, and to transmit, if the specified first electronic device and the specified second electronic device are a single electronic device, the video data and the audio data contained in the content data to the single electronic device by a wireless signal.

6. The data transmission apparatus according to claim 5, further comprising a reporting unit configured to inform, if the specified first electronic device and the specified second electronic device are different electronic devices, the source device of device information of the first electronic device, which indicates a video data format that is displayable by the specified first electronic deice, and device information of the second electronic device, which indicates an audio data format that is processible by the specified second electronic device, and to inform, if the specified first electronic device and the specified second electronic device are a single electronic device, the source device of device information of the single electronic device, which indicates a video data format that is displayable by the single electronic deice and an audio data format that is processible by the single electronic device.

7. A data transmission method which controls a data transmission apparatus which is connected to a source device, and transmits content data, which is output from the source device, to one or more of a plurality of electronic devices by a wireless signal, the method comprising:
detecting functions of the plurality of electronic devices by wireless communication with each of the plurality of electronic devices;
classifying the plurality of electronic devices into a plurality of groups in accordance with the detected functions of the plurality of electronic devices and generating list information indicative of a list of structures of the plurality of groups, each of the groups including a combination of an electronic device which is usable for video display and an electronic device which is usable for audio output, or an electronic device which is usable for both the video display and the audio output;
transmitting the generated list information to the source device; and
specifying, in accordance with selection information which is output from the source device and designates one of the plurality of electronic devices, a first electronic device of the plurality of electronic devices, to which video data contained in the content data is to be transmitted, and a second electronic device of the plurality of electronic devices, to which audio data contained in the content data is to be transmitted; and
transmitting the video data and the audio data contained in the content data to the specified first electronic device and the specified second electronic device by wireless signals if the specified first electronic device and the specified second electronic device are different electronic devices, and transmitting, if the specified first electronic device and the specified second electronic device are a single electronic device, the video data and the audio data contained in the content data to the single electronic device by a wireless signal.

8. The data transmission method according to claim 7, wherein the source device outputs, in response to an operation of a predetermined button provided on the source device, a message which instructs a transmission-destination electronic device to execute video display or audio output and to which the selection information is added, and starts output of the content data, and
said specifying includes specifying the first electronic device and the second electronic device in accordance with the selection information which is added to the message that is output from the source device.

9. The data transmission method according to claim 8, wherein said transmitting includes transmitting, if the specified first electronic device and the specified second electronic device are different electronic devices, the message and the video data contained in the content data to the specified first electronic device by a wireless signal and the message and the audio data contained in the content data to the specified second electronic device by a wireless signal.

10. The data transmission method according to claim 9, wherein said transmitting includes transmitting, if the specified first electronic device and the specified second electronic device are a single electronic device, the message and the video data and the audio data contained in the content data to the single electronic device by a wireless signal.
